(19) United States
(12) Patent Application Publication
(10) Pub. No.: US 2016/0339781 A1
(43) Pub. Date: Nov. 24, 2016

(54) MOBILITY AID WITH AN AUTOMATIC TURNING DECELERATION DEVICE

(71) Applicant: Shu-Chen CHAN, Changhua County (TW)

(72) Inventor: Shu-Chen CHAN, Changhua County (TW)

(21) Appl. No.: 15/226,337

(22) Filed: Aug. 2, 2016

Related U.S. Application Data
(63) Continuation-in-part of application No. 14/318,332, filed on Jun. 27, 2014.

(51) Int. Cl. B60K 31/00; B62D 15/02

(52) U.S. Cl. CPC B60K 31/0075; B62D 15/0215

(57) ABSTRACT

A mobility aid has a body, a stem, a handle bar, a fixing frame two rear wheels, two motors, a brake-releasing lever, and an automatic turning deceleration device. The automatic turning deceleration device has a fixing base, a fixing unit, a turning sensor, a turning base, a linking unit, and a control module. The turning sensor is rotatably mounted on a side of the fixing unit. The turning base is mounted around the turning sensor. The linking unit is combined on the turning base and abuts the turning sensor. The control module is mounted on a side of the turning base and links between the fixing base and the turning base. Therefore, the automatic turning deceleration device can provide a stable and steady decelerating effect for the mobility aid.

The present invention is a continuation-in-part of the application Ser. No. 14/318,332, filed on Jun. 27, 2014, the entire disclosure of which is incorporated herein by reference.

### BACKGROUND OF THE INVENTION

1. Field of the Invention

The present invention relates to a mobility aid, and more particularly to a mobility aid with an turning deceleration device.

2. Description of Related Art

A mobility aid is applied for assisting a user with reduced mobility to move easily. To maintain turning stability for the mobility aid, a proximity switch is mounted on a stem of the mobility aid. The stem is rotated by the user for turning the mobility aid. When the stem is rotated to a default angle, the proximity switch come into contact with a sensor, and then the sensor transmits a deceleration signal to a motor of the controller to control the mobility aid to decelerate and to prevent overturning.

However, the deceleration signal is transmitted only when the proximity switch contacts the sensor, such that the motor decelerates promptly in a short time. Therefore, the decelerating effect of the mobility aid cannot be maintained stable and steady.

### SUMMARY OF THE INVENTION

The main objective of the present invention is to provide a mobility aid having an automatic turning deceleration device to resolve the above-mentioned problems.

The mobility aid has a body, a stem, a handle bar, a fixing frame, two rear wheels, two motors, at least one front wheel, a brake-releasing lever, and an automatic turning deceleration device.

The stem is mounted on a front side of the body. The handle bar is mounted on a top of the stem. The fixing frame is mounted on the stem to fix the stem on the body. The rear wheels are mounted rotatably on a rear of the body and are respectively located on two sides of the body. The at least one motor is mounted on the body to drive the rear wheels to rotate. The at least one front wheel is rotatably connected with the stem. The automatic turning deceleration device is mounted between a bottom of the stem and the fixing frame and is electrically connected with the at least one motor. The automatic turning deceleration device has a fixing base, a fixing unit, a turning sensor, a turning base, a linking unit, and a control module.

The turning sensor is rotatably mounted on a side of the fixing unit. The turning base is mounted around the turning sensor. The linking unit is combined on the turning base and abuts the turning sensor. The control module is mounted on a side of the turning base and links between the fixing base and the turning base.

Other objectives, advantages and novel features of the present invention will become more apparent from the following detailed description when taken in conjunction with the accompanying drawings.

### BRIEF DESCRIPTION OF THE DRAWINGS

FIG. 1 is a partially perspective view of a mobility aid in accordance with the present invention;

FIG. 2 is an enlarged perspective view of the automatic turning deceleration device of the mobility aid in FIG. 1;

FIG. 3 is an exploded perspective view of the automatic turning deceleration device in FIG. 2;

FIG. 4 is an enlarged front side view in partial section of the automatic turning deceleration device in FIG. 2;

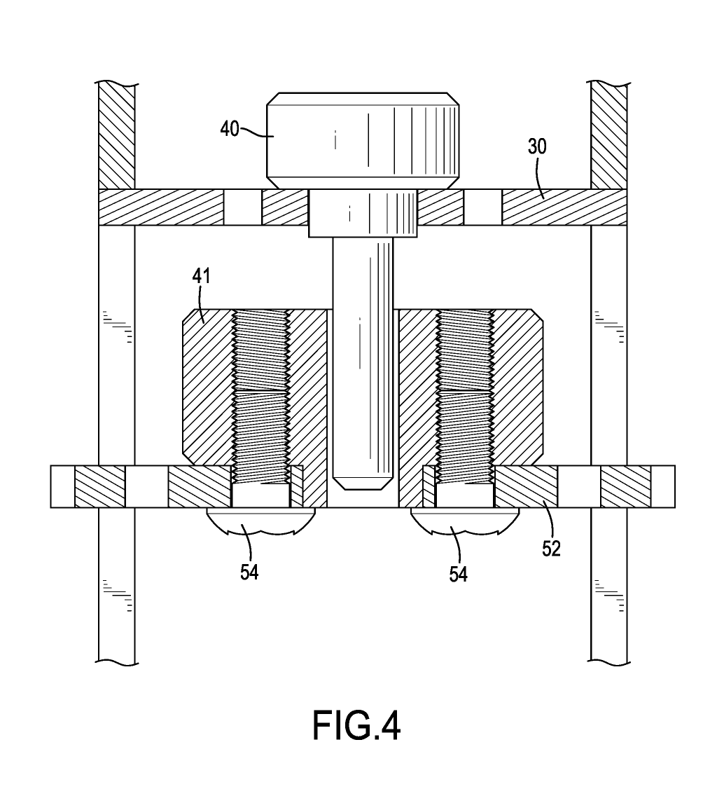

FIG. 5 is an enlarged side view in partial section of the automatic turning deceleration device in FIG. 2;

FIGS. 6A and 6B show operational bottom views of the automatic turning deceleration device in FIG. 2; and

FIG. 7 is a block diagram of the mobility in FIG. 1.

### DETAILED DESCRIPTION OF PREFERRED EMBODIMENT

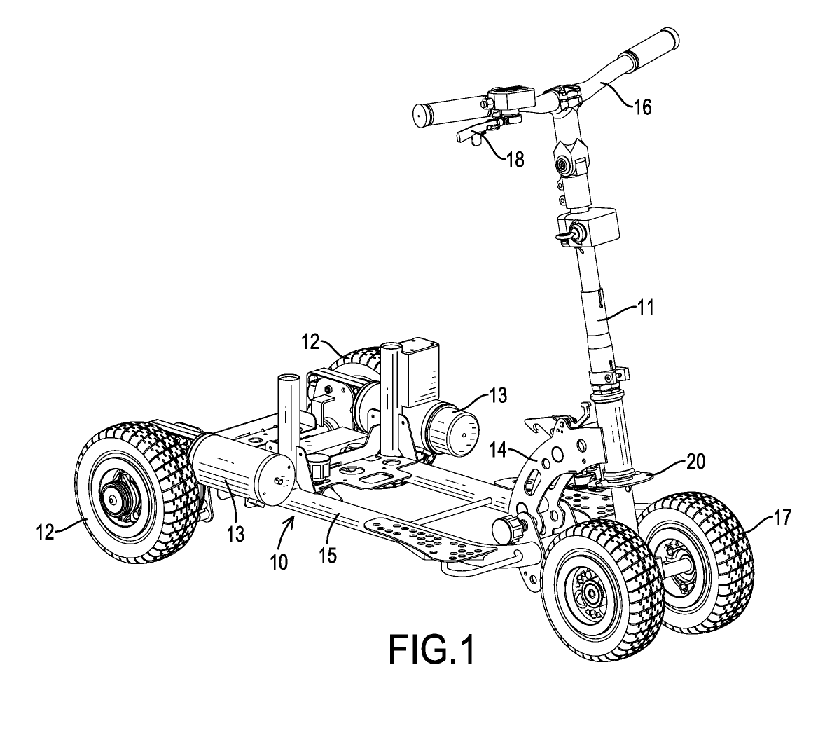

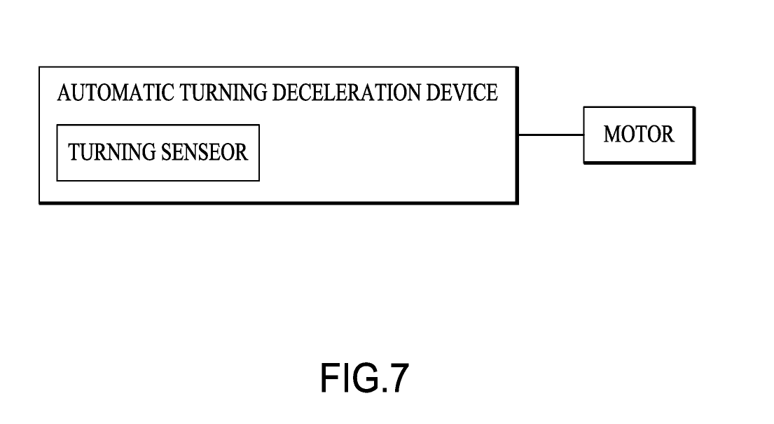

With reference to FIGS. 1 and 7, a mobility aid 10 in accordance with the present invention comprises a body 15, a stem 11, a handle bar 16, a fixing frame 14, two rear wheels 12, at least one front wheel 17, two motors 13, a brake-releasing lever 18, and an automatic turning deceleration device. The body 15 may have a seat mounted thereon, such that the rider can sit on the seat for riding the mobility aid 10. The stem 11 is mounted on a front side of the body 15. The handle bar 16 is mounted on a top of the stem 11 and is applied for a user to control a moving direction of the mobility aid 10. The fixing frame 14 is mounted on the stem 11 to fix the stem 11 on the body 15. The rear wheels 12 are mounted rotatably on a rear of the body 15 and are respectively located on two sides of the body 15. The motors 13 are respectively mounted on the two sides of the body 15 and respectively drive the rear wheels 12. Alternatively, the mobility aid 10 may only have a motor 13 mounted on one of the sides of the body 15 for driving the rear wheels 12. The at least one front wheel 17 is rotatably connected with the stem 11. Preferably, two front wheels are implemented in amount. When the stem 11 is turned, the moving direction of the front wheels is changed and the mobility aid 10 can be turned right or left. The brake-releasing lever is mounted on the handlebar. When the brake-releasing lever is not pulled, the mobility aid 10 is kept stationary. When the brake-releasing lever is pulled, the mobility aid 10 can move forward.

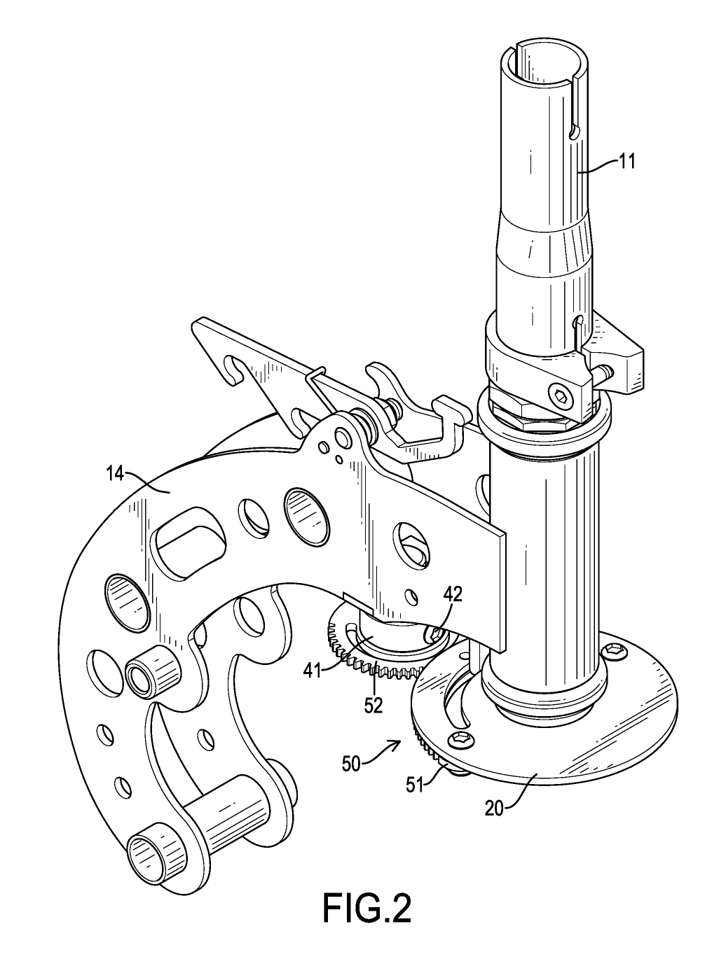

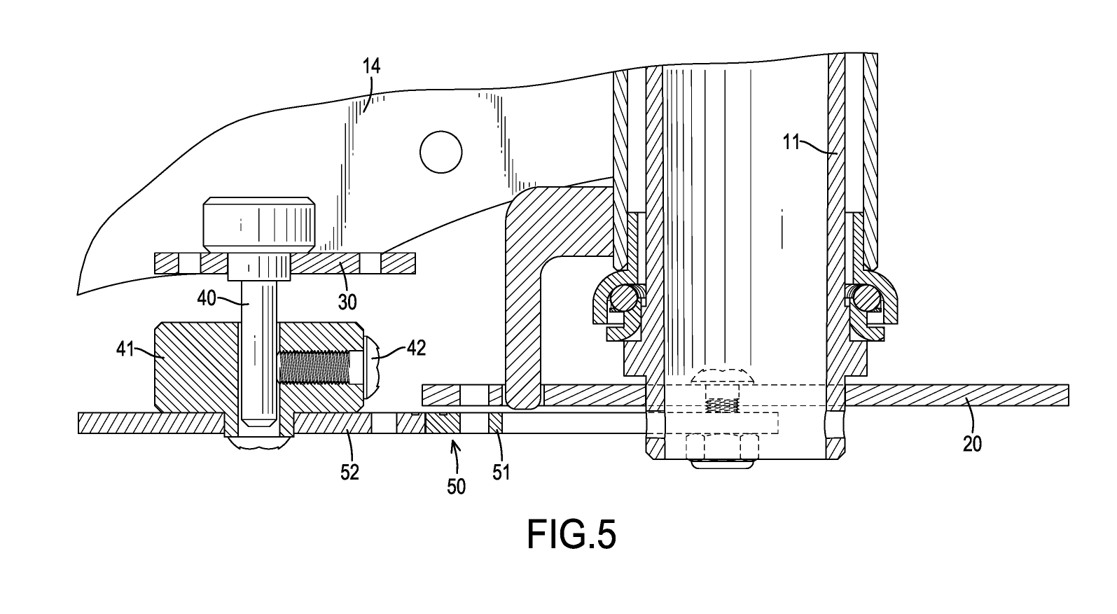

With reference to FIGS. 1, 2, 5 and 7, the automatic turning deceleration device is mounted between a bottom of the stem 11 and the fixing frame 14, is electrically connected with the motors 13, and has a fixing base 20, a fixing unit 30, a turning sensor 40, a turning base 41, a linking unit 42 and a control module 50.

The fixing base 20 is mounted on the bottom of the stem 11. The fixing unit 30 is mounted on the fixing frame 14. Preferably, the fixing unit 30 is formed as a fixing plate. The turning sensor 40 is rotatably mounted on the fixing unit 30 and is capable of transmitting a linear decelerating signal to an electronic control system. The turning base 41 is mounted around the turning sensor 40 and is rotatable relative to the fixing unit 30. The linking unit 42 is inserted into a side of the turning base 41, is combined with the turning base 41 and abuts the turning sensor 40, such that the linking unit 42 can drive the turning base 41 to rotate when the automatic turning deceleration device is turned. The turning sensor 40 is electrically connected with the motors 13. Preferably, the turning sensor 40 is a variable resistor or a potentiometer.

The control module 50 is mounted on the fixing base 20 and a bottom of the turning base 41, and is linked between the fixing base 20 and the turning base 41. The control module 50 has a main control pad 51 and a secondary control pad 52. The main control pad 51 is mounted on a bottom of the fixing base 20. Preferably, the main control pad 51 is mounted on the bottom of the fixing base 20 by two bolts 53. The main control pad 51 is formed in a curved shape and has multiple first engaging teeth 511. The first engaging teeth 511 are formed on a side of the main control pad 51 and are arranged at intervals. The secondary control pad 52 is mounted on a bottom of the turning base 41. Preferably, the secondary control pad 52 is mounted on the bottom of the turning base 41 by two bolts 54. The secondary control pad 52 has multiple second engaging teeth 521. The second engaging teeth 521 are formed on a side of the secondary control pad 52, are arranged at intervals, and are engaged with the first engaging teeth 511. When the first control pad 51 is rotated, the second control pad 52 is driven to rotate by the cooperation between the first engaging teeth 511 and the second engaging teeth 521. The linking structure between the control module 50 and the turning base 41 is not restricted in the present invention. The control module 50 may be a linking lever linking between the fixing base 20 and the turning base 41 to drive the turning base 41 to rotate.

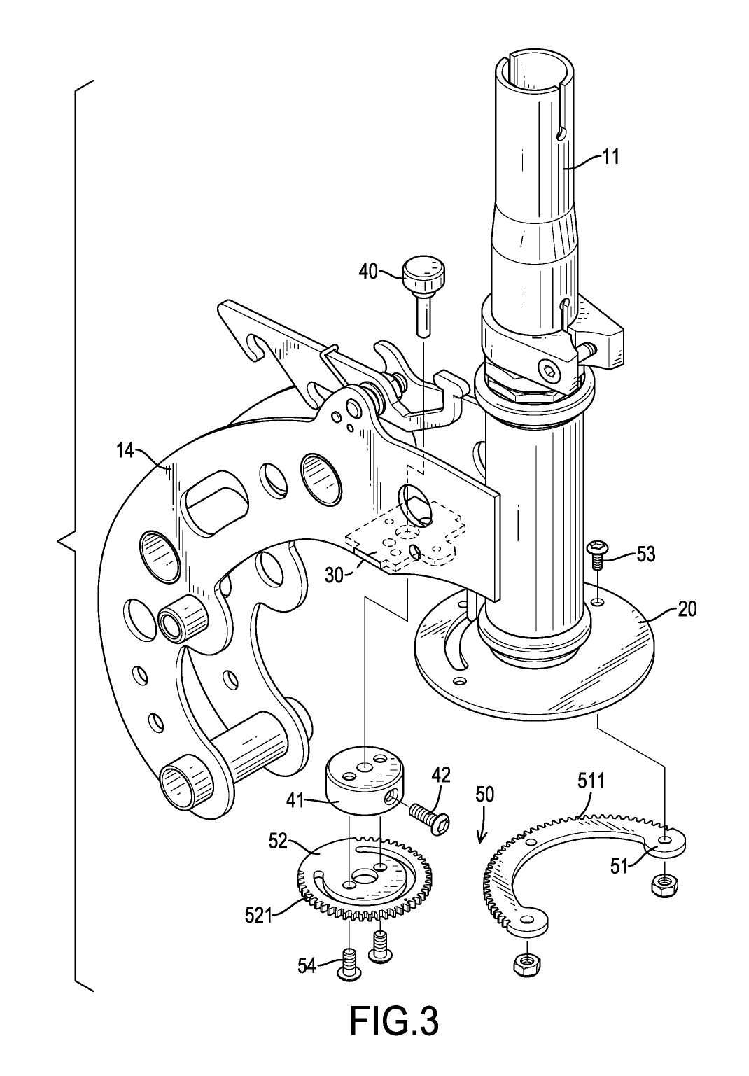

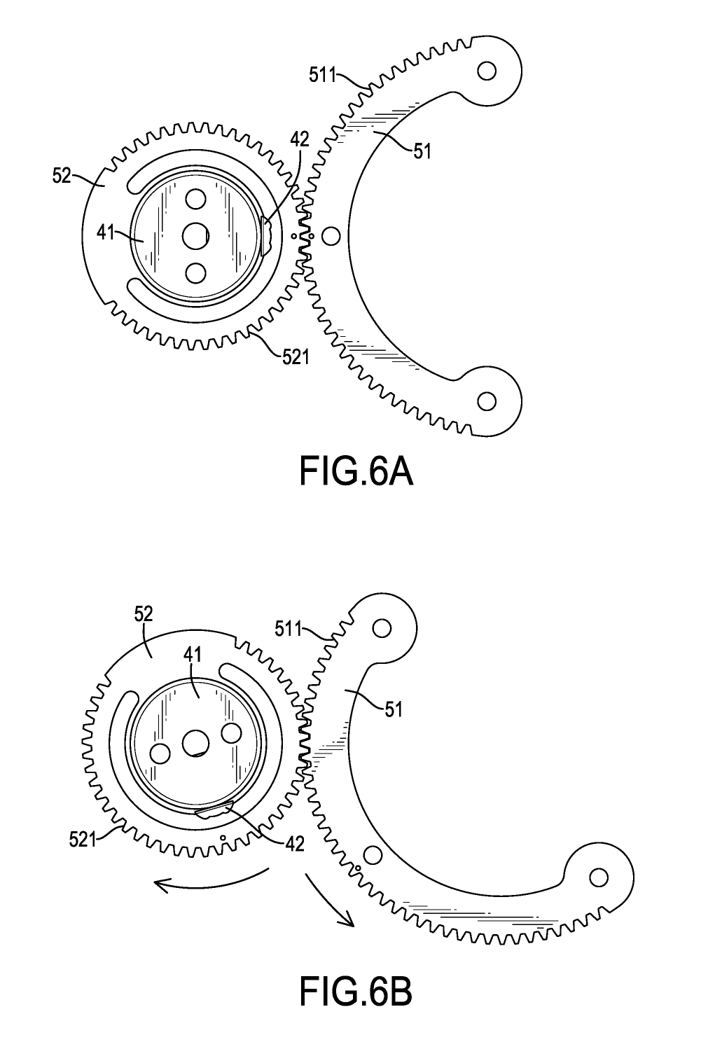

With reference to FIGS. 3, 5, 6A and 6B, in use, a rider sits on the seat of the body 15 and holds the handlebar 16. When the brake-releasing lever 18 is pulled, the rear wheels 12 are actuated by the motors 13 to rotate and the mobility aid 10 moves forward. When stem 11 is not turned, the turning base 41 is not rotated and the turning sensor 40 is not driven to rotate. Accordingly, the turning sensor 40 is kept from transmitting a decelerating signal to an electronic control system and the motors 13 of the mobility aid 10. Therefore, the motors 13 operate at a speed that is controlled by a user.

When t the stem 11 is turned to control the mobility aid 10 to turn left or right, the fixing base 20 drives the main control pad 51 to rotate, and then the main control pad 51 controls the secondary control pad 52 to rotate by the first engaging teeth 511. When the secondary control pad 52 is rotated, the turning base 41 is driven to rotate and then the turning sensor 40 is driven to rotate by the linking unit 42. After the turning sensor 40 is rotated, the turning sensor 40 can transmit the linear decelerating signal to the electronic control system and the motors 13 of the mobility aid 10. As a rotation angle of the turning sensor 40 enlarges, the decelerating signal transmitted to the motors 13 intensifies accordingly, such that the motors 13 can decelerate for a stable and steady turning effect. Thus, the mobility can be automatically slowed down stably while the mobility aid 10 is turned right or left even when the brake-releasing lever 18 is not released.

From the above description, it is noted that the present invention has the following advantages: In use, the fixing base 20 is mounted on the stem 11 of the mobility aid 10. When the stem 11 is rotated, the fixing base 20 can be rotated to further drive the turning base 41 to rotate by the control module 50. Then, the linking unit 42 is applied for driving the turning sensor 40 to rotate, wherein the turning sensor 40 is electrically connected with the electronic control system and the motors 13 of the mobility aid 10. Therefore, when the turning sensor 40 is rotated, the linear decelerating signal is transmitted to the motors 13. Along with the increasing of the rotation angle of the turning sensor 40, the decelerating effect of the motors 13 becomes enhanced. Therefore, when the mobility aid 10 is turned right or left, the automatic turning deceleration device can be applied to control the motors 13 to decelerate steadily, stably and effectively to increase a turning security.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobility aid having:
a body;
a stem mounted on a front side of the body;
a handle bar mounted on a top of the stem;
a fixing frame mounted on the stem to fix the stem on the body;
two rear wheels mounted rotatably on a rear of the body and respectively located on two sides of the body;
at least one motor mounted on the body to drive the rear wheels to rotate;
at least one front wheel rotatably connected with the stem;
a brake-releasing lever mounted on the handlebar; and
an automatic turning deceleration device mounted between a bottom of the stem and the fixing frame, electrically connected with the at least one motor, and comprising
a fixing base mounted on the bottom of the stem;
a fixing unit mounted on the fixing frame;
a turning sensor rotatably mounted on a side of the fixing unit, electrically connected with the at least one motor, and capable of transmitting a linear decelerating signal to an electronic control system;
a turning base mounted around the turning sensor and being rotatable relative to the fixing unit;
a linking unit combined with the turning base and abutting the turning sensor; and
a control module mounted on a side of the turning base and a bottom of the turning base and linked between the fixing base and the turning base.

2. The mobility aid as claimed in claim 1, wherein the control module has
a main control pad mounted on a side of the fixing base; and
a secondary control pad mounted on the side of the turning base and engaged with the main control pad.

3. The mobility aid as claimed in claim 2, wherein the fixing unit is formed as a fixing plate.

4. The mobility aid as claimed in claim 3, wherein the main control pad is mounted on the fixing base by two bolts.

5. The mobility aid as claimed in claim 4, wherein the secondary control pad is mounted on the turning base by two bolts.

6. The mobility aid as claimed in claim 5, wherein the main control pad is mounted on a bottom of the fixing base, and the secondary control pad is mounted on a bottom of the turning base.

7. The mobility aid as claimed in claim 6, wherein the main control pad is formed in a curved shape.

8. The mobility aid as claimed in claim 2, wherein
the main control pad has multiple first engaging teeth;
the secondary control pad has multiple second engaging teeth; and
the first engaging teeth are engaged with the second engaging teeth.

9. The mobility aid as claimed in claim 3, wherein
the main control pad has multiple first engaging teeth;
the secondary control pad has multiple second engaging teeth; and
the first engaging teeth are engaged with the second engaging teeth.

10. The mobility aid as claimed in claim 4, wherein
the main control pad has multiple first engaging teeth;
the secondary control pad has multiple second engaging teeth; and
the first engaging teeth are engaged with the second engaging teeth.

11. The mobility aid as claimed in claim 5, wherein
the main control pad has multiple first engaging teeth;
the secondary control pad has multiple second engaging teeth; and
the first engaging teeth are engaged with the second engaging teeth.

12. The mobility aid as claimed in claim 6, wherein
the main control pad has multiple first engaging teeth;
the secondary control pad has multiple second engaging teeth; and
the first engaging teeth are engaged with the second engaging teeth.

13. The mobility aid as claimed in claim 7, wherein
the main control pad has multiple first engaging teeth;
the secondary control pad has multiple second engaging teeth; and
the first engaging teeth are engaged with the second engaging teeth.
